(19) United States
(12) Patent Application Publication
(10) Pub. No.: US 2026/0169619 A1
(43) Pub. Date: Jun. 18, 2026

(54) METHOD, APPARATUS, DEVICE AND STORAGE MEDIUM FOR CONTENT INTERACTION

(71) Applicants: Lemon Inc., Grand Cayman (KY); Beijing Zitiao Network Technology Co., Ltd., Beijing (CN)

(72) Inventors: Lingshuang KONG, Culver City, CA (US); Lingxuan SHEN, Beijing (CN); Zhenan LI, Beijing (CN); Weijian CHEN, Beijing (CN)

(21) Appl. No.: 19/416,858

(22) Filed: Dec. 11, 2025

(30) Foreign Application Priority Data
Dec. 16, 2024 (WO) PCT/CN2024/139753

(51) Int. Cl. G06F 3/04847; G06T 11/60

(52) U.S. Cl. CPC G06F 3/04847; G06T 11/60; G06T 2200/24

(57) ABSTRACT

A method includes: presenting a viewing interface of static media content posted by a first user; providing, based on an interaction request received in the viewing interface, dynamic media content generated based on the static media content; and sending, in response to receiving a sending request, target media content in a chat with the first user, wherein the target media content is the dynamic media content or the target media content is generated by editing the dynamic media content.

### CROSS-REFERENCE

The present application claims priority to PCT Application No. PCT/CN2024/139753, filed on Dec. 16, 2024, and entitled “METHOD, APPARATUS, DEVICE AND STORAGE MEDIUM FOR CONTENT INTERACTION”, the entirety of which is incorporated herein by reference.

### FIELD

Example embodiments of the present disclosure generally relate to the field of computers, and in particular, to methods, apparatuses, devices, and computer-readable storage media for content interaction.

### BACKGROUND

With the development of computer technologies, more and more users utilize the Internet for chats. For example, the user may interact with other users by using an instant messaging application or an instant messaging service provided by another application. The user can support message interaction of multiple modalities during the process of chat interaction. For example, a user may send a text message, a voice message, or an image message in a chat.

### SUMMARY

In a first aspect of the present disclosure, a method for content interaction is provided. The method includes: presenting a viewing interface of static media content posted by a first user; providing, based on an interaction request received in the viewing interface, dynamic media content generated based on the static media content; and sending, in response to receiving a sending request, target media content in a chat with the first user, wherein the target media content is the dynamic media content or the target media content is generated by editing the dynamic media content.

In a second aspect of the present disclosure, an apparatus for content interaction is provided. The apparatus includes: a presenting module configured to present a viewing interface of static media content posted by a first user; a providing module configured to provide, based on an interaction request received in the viewing interface, dynamic media content generated based on the static media content; and a sending module configured to send, in response to receiving a sending request, target media content in a chat with the first user, wherein the target media content is the dynamic media content or the target media content is generated by editing the dynamic media content.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIGS. 2A to 2F illustrate example interfaces in accordance with some embodiments of the present disclosure;

FIG. 3 illustrates a flowchart of an example process of content interaction according to some embodiments of the present disclosure;

FIG. 4 illustrates a schematic structural block diagram of an example apparatus for content interaction according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including/comprising” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, processed, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and only within a specified or agreed range. The user rejection of processing of personal information other than necessary information required by the basic function will not affect the basic function of the user.

As mentioned above, static and dynamic image interactions that interact in a chat are a class of important interaction ways. For example, in a chat scenario, participants of a chat may, for example, send static and dynamic image messages. According to conventional solutions, the static and dynamic image messages that a participant can send in a chat are typically only predetermined or pre-stored images. This affects richness and interestingness of image messages in the chat to some extent.

Embodiments of the disclosure provide a solution for content interaction. The solution comprises: presenting a viewing interface of static media content posted by a first user; providing, based on an interaction request received in the viewing interface, dynamic media content generated based on the static media content; and sending, in response to receiving a sending request, target media content in a chat with the first user, wherein the target media content is the dynamic media content or the target media content is generated by editing the dynamic media content.

In this way, the embodiments of the disclosure can generate the corresponding dynamic media content based on the static media content posted by the user, so that the interaction content between the users is associated with the content posted by the user, the interaction material between the users is enriched, and the interestingness and interactivity of the information interaction are improved.

Various example implementations of this solution are described in detail below in conjunction with the accompanying drawings.

### Example Environment

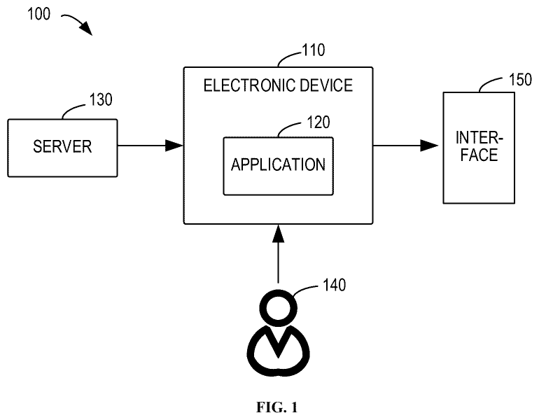

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports content interaction. The application 120 may be any suitable type of application for content interaction, examples of which may include, but are not limited to, instant messaging applications or other suitable applications that provide instant messaging services. A user 140 may interact with the application 120 via the electronic device 110 and/or its attachment device.

In the environment 100 of FIG. 1, if the application 120 is active, the electronic device 110 may present, via the application 120, an interface 150 for supporting content interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support content interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

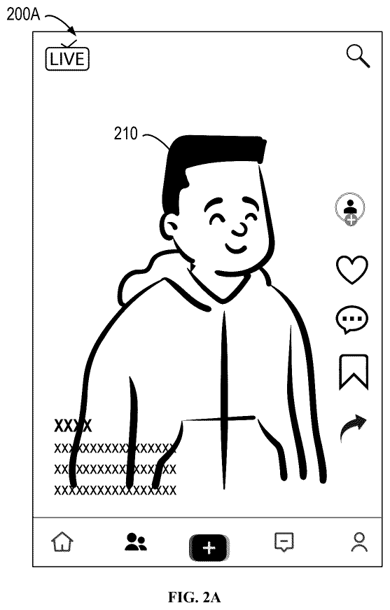

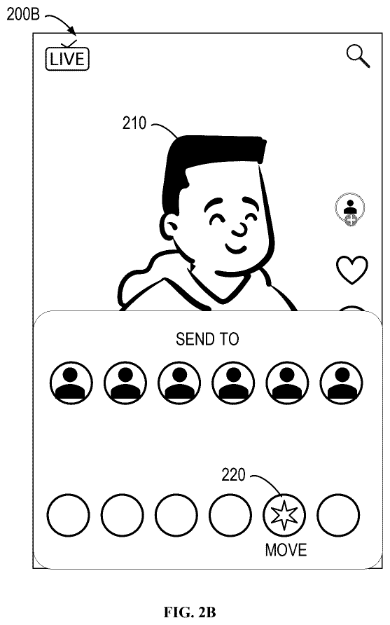

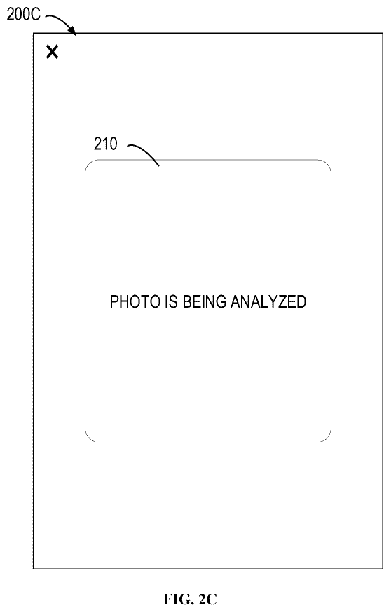

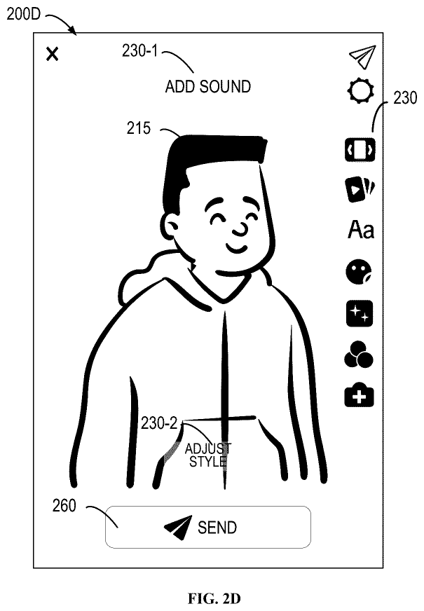

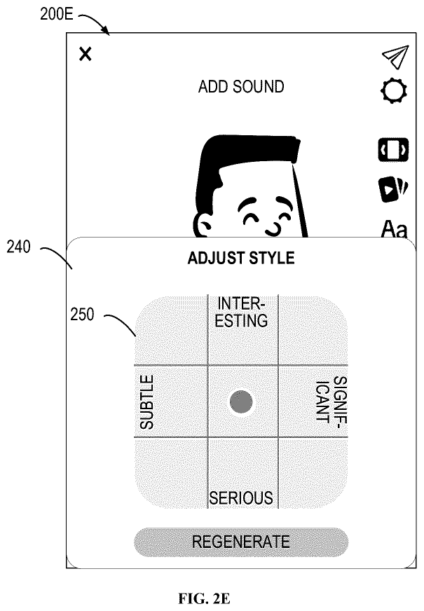

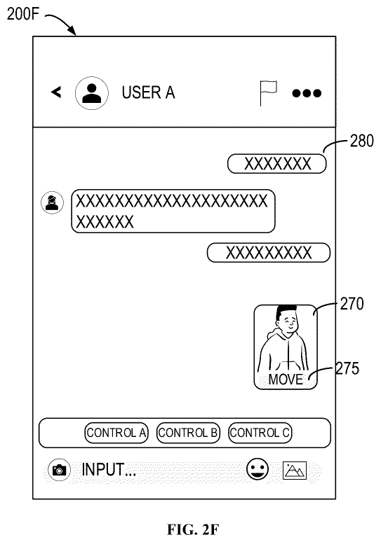

FIGS. 2A to 2F illustrate example interfaces 200A to 200F, in accordance with some embodiments of the present disclosure. The interface 200A to the interface 200F may be provided, for example, by the electronic device 110 shown in FIG. 1.

As shown in FIG. 2A, the electronic device 110 presents a viewing interface 200A of static media content 210 posted by a first user (e.g., user A). The static media content 210 may be captured or uploaded by the user A. It should be appreciated that the obtaining and use of such static media content 210 is performed with user awareness and authorization. As an example, the static media content 210 may include a picture.

Additionally, the electronic device 110 may also determine whether the static media content 210 (e.g., a captured image or an uploaded image) satisfies a predetermined requirement. Such predetermined requirements may be related to, for example, content, quality, and/or size of the image. For example, the predetermined requirement may include that a specific type of object needs to be included in the image.

In some embodiments, the static media content 210 used for the dynamic media content may be obtained in a plurality of manners, such as being selected from a plurality of images posted by the user A or intercepted in the dynamic media content posted by the user A, which is not limited herein.

In some embodiments, the electronic device 110 may receive a first operation for the static media content 210 by a user (e.g., the first user or a second user in a chat with the first user). For example, the electronic device 110 may receive a user's click or other appropriate action on the static media content 210. Accordingly, in response to receiving the first operation, the electronic device 110 may present the interface 200B as shown in FIG. 2B.

In some embodiments, the electronic device 110 may provide one or more content controls, such as a dynamic control 220, via interface 200B. As an example, the electronic device 110 may provide an interface 200C in the dynamic media content generation or present an editing interface for the dynamic media content based on a user selection of the dynamic control 220.

In some embodiments, in response to a user selection of the dynamic control 220, the electronic device 110 may present the interface 200C as shown in FIG. 2C during generation of the dynamic media content. The electronic device 110 may present, via the interface 200C, generation status information of the dynamic media content, such as photo being analyzed, content being generated, etc. As an example, progress information may indicate a completed progress (e.g., 50%) of the generation process, a remaining progress of the generation process (e.g., remaining time), and so on. It should be understood that the progress information may be presented in any suitable form, examples of which may include, but are not limited to, a progress bar, a percentage number, etc.

In some embodiments, in response to a user selection of the dynamic control 220, after the generation of the dynamic media content 215 is completed, the electronic device 110 may present an editing interface 200D of the dynamic media content 215 as shown in FIG. 2D. The electronic device 110 may generate target media content based on at least one edit operation received in the editing interface 200D.

As shown in FIG. 2D, the editing interface 200D is presented with the dynamic media content 215 and a plurality of adjustment controls 230, and the electronic device 110 may receive the user's click or other appropriate operation on the adjustment control 230. For example, the user may adjust at least one update parameter (e.g., a chroma, a brightness, a filter, or the like) of the dynamic media content 215 by using the adjustment control 230, and may further add at least one update parameter, such as a text, an expression, a sticker, or the like, into the dynamic media content 215 through the adjustment control 230, to trigger generation of the target media content based on the static media content 210 and the at least one update parameter, and enrich the presentation effect of the dynamic media content 215.

In some embodiments, the electronic device 110 may receive a click or other suitable operation of the user on an adjustment control 230-1, that is, a sound control, and add sound content to the dynamic media content 215 to further enrich the presentation effect of the dynamic media content 215.

In some embodiments, the adjustment control 230 may further include a control for selecting a predetermined condition to obtain predetermined first motion control information; a control for obtaining the static media content 210 to obtain second motion control information determined based on the static media content 210; and/or a control for inputting information to obtain third motion control information determined based on user input information.

In some embodiments, various condition information may be predetermined in the electronic device 110, for example, a path from point A to point B in the image, or a specific motion template such as simple swinging, jumping, dance, repeated motion or set of consecutive motions, dance type, or the like. The electronic device 110 may receive a click or other suitable operation of the user on the adjustment control 230 or based on default settings to obtain predetermined first motion control information.

In some embodiments, the electronic device 110 may perform content analysis on the static media content 210, for example, obtaining image information (e.g., main body content and environmental content included in the image) in the static media content 210, and determine second motion control information based on such information.

In some embodiments, the dynamic media content 215 indicates a motion associated with a predetermined object (e.g., main body content) in the static media content 210. The predetermined object may be one or more objects, such as a person, two cats, a plurality of same or different animals or items, such as fallen leaves on a tree, flowers in a garden, and the like. Correspondingly, the motion associated with the predetermined object may be actions such as laughing, crying, dancing and the like performed by the person, actions such as running and jumping interaction of the cat, falling of fallen leaves on the tree, blossom or withering of flowers, etc., which is not limited herein.

In some embodiments, at least part of the image in the static media content 210 that is independent of the predetermined object remains in a stationary state. For example, the electronic device 110 obtains image information in the static media content 210. For example, if the main body content is a person, and the environmental content is a room, the associated second motion control information may be a person moving or dancing in the room, where the person is set as the predetermined object to present a corresponding motion, and the environmental content other than the predetermined object, that is, the room, remains in the stationary state.

In some embodiments, when there are multiple predetermined objects in the static media content 210, the associated second motion control information may be set separately or jointly. The electronic device 110 obtains image information in the static media content 210. For example, if the main body content is a person and a cat, and the environmental content is a garden, the user may separately set a motion of the person as laughing, crying, dancing, etc., and a motion of the cat is running, jumping, etc. The user may also set both of them to perform the same motion. The user may also set the two together to perform some motion, for example, playing with cats, feeding, etc., which is not limited herein.

In some embodiments, the predetermined object in the static media content 210 may be selected by default or self-selected by the user. When the electronic device 110 obtains image information in the static media content 210, for example, if the main body content is leaves and the environmental content is a forest, the default predetermined object may be all leaves, and the predetermined object may also be adjusted by the user to be, for example, a specified number of leaves or leaves with a color yellow, and the unselected part is merged into the environmental content. The leaf selected as the predetermined object presents a motion of falling, and the rest of the image content remains stationary.

In some embodiments, the user input information includes at least one of: motion description text, an interaction operation indicating a motion trajectory, or reference media content. Based on such information, third motion control information may be determined. The electronic device 110 may be preset with a plurality of motion trajectories or motion templates, and the motion of the predetermined object may be customized through the user input information.

In some embodiments, the electronic device 110 obtains the motion description text, and may set a motion type of the predetermined object. For example, if “let the object jump” or the like is input, the predetermined object such as a person, a cat, or the like is set to perform a corresponding motion. For example, when the predetermined object is a leaf, the default motion corresponding to the predetermined object may be only falling, and the content such as “let the leave drift down” may be input to describe the motion, such that the motion type is enriched beyond the predetermined motion.

In some embodiments, the electronic device 110 obtains an interaction operation indicating a motion trajectory, and may adjust a motion trajectory of the predetermined object. The user may directly perform trajectory drawing on the interface, or set the motion trajectory by describing a trajectory. For example, the predetermined object in its motion is a cat running, and the running path of the hair of the cat may be set through the interaction operation for the motion trajectory, such that the flexibility of motion control is improved.

In some embodiments, the electronic device 110 may adjust a motion of the predetermined object according to the reference media content, and the reference media content may be a video or a dynamic image. For example, the predetermined object in its motion is a person dancing, and the electronic device 110 may set the motion of the predetermined object according to the reference media content, such as a dance video, so as to simplify the setting process of a complicated motion. As an example, the reference media content may not only serve as a reference of the predetermined object but also serve as a reference of the environmental content. For example, if the predetermined object in the static media content 210 in its motion is a person dancing, the environmental content is a room, and the environmental content in the reference media content is a stage, then the corresponding generated dynamic media content 215 may be a person dancing on the stage.

In some embodiments, one or more pieces of the plurality of pieces of user input information such as the motion description text, the interaction operation indicating the motion trajectory, the reference media content, etc., may be combined to serve as a motion reference of the predetermined object in the dynamic media content 215. Similarly, one or more pieces of the first motion control information, the second motion control information, and the third motion control information may be combined to serve as a motion reference of a predetermined object in the dynamic media content 215.

As shown in FIG. 2D, the editing interface 200D further includes an adjustment control 230-2, and the electronic device 110 may present the editing interface 200E of the dynamic media content 215 as shown in FIG. 2E in response to a user's click or other appropriate operation on the adjustment control 230-2, that is, the style adjustment entry.

As shown in FIG. 2E, the editing interface 200E presents an adjustment window 240. The electronic device 110 may obtain the at least one update parameter via an adjustment control 250 associated with at least one attribute in the adjustment window 240. As shown in FIG. 2E, the adjustment control 250 may include a matrix control corresponding to two attributes, and values in different dimensions of the matrix control indicate parameter values of respective attributes.

In some embodiments, the horizontal dimension of the matrix control indicates the amplitude of the motion, the longitudinal dimension indicates the style of the motion, and the matrix control may be combined with the adjustment control 230 described above to fine tune the generated dynamic media content 215. Upon completion of the adjustment and generation of the dynamic media content 215, the electronic device 110 may present an editing interface 200D of the dynamic media content 215 as shown in FIG. 2D.

It should be understood that the dynamic media content 215 may be generated using any suitable media generation model, examples of which may include, but are not limited to, generative models. Such a generative model may, for example, use static media content and a prompt as model input information, and generate corresponding dynamic media content, for example, a dynamic image or video.

As shown in FIG. 2D, the editing interface 200D further includes a sending control 260, in response to the user's click or other appropriate operation on the sending control 260, the electronic device 110 receives the sending request, the electronic device 110 may present the chat interface 200F as shown in FIG. 2F, and send the target media content 270 in the chat with the first user, where the target media content 270 is the dynamic media content 215, or the target media content 270 is generated by editing the dynamic media content 215.

As shown in FIG. 2F, a chat interface 200F may correspond to the current user's chat with the first user. As shown in FIG. 2F, the chat interface 200F may include a message area 280 for displaying a message sent and received in the chat. The target media content 270 is presented in the message area 280 in the form of a message.

The above chat interface corresponds to an example chat (e.g., a one-on-one chat) of two participants, and embodiments of the present disclosure may also be applicable to a chat scenario (e.g., a group chat) including multiple participants.

In some embodiments, an element 275 (e.g., text “move”) associated with the target media content 270 is also presented in chat interface 200F to indicate that target media content 270 is generated based on the static media content 210.

In this way, the embodiments of the present disclosure can generate the corresponding dynamic media content 215 based on the static media content 210 posted by the user, so that the interaction content between the users is associated with the content posted by the user, the interaction material between the users is enriched, and the interestingness and interactivity of the information interaction are improved.

### Example Processes

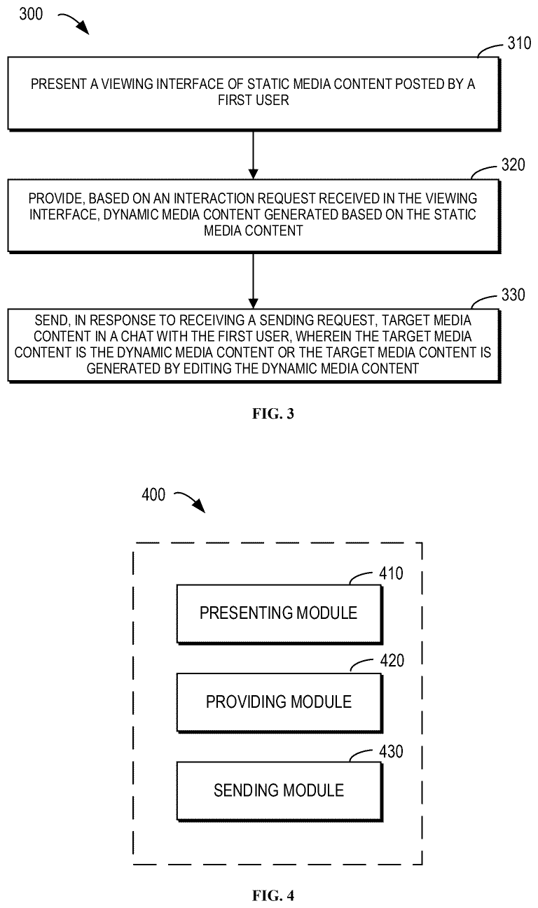

FIG. 3 illustrates a flowchart of an example process 300 of content interaction in accordance with some embodiments of the present disclosure. The process 300 may be implemented at the electronic device 110. The process 300 is described below with reference to FIG. 1.

As shown in FIG. 3, at block 310, the electronic device 110 presents a viewing interface of static media content posted by a first user.

At block 320, the electronic device 110 provides, based on an interaction request received in the viewing interface, dynamic media content generated based on the static media content.

At block 330, the electronic device 110 sends, in response to receiving a sending request, target media content in a chat with the first user, wherein the target media content is the dynamic media content or the target media content is generated by editing the dynamic media content.

In some embodiments, an editing interface of the dynamic media content is presented; and target media content is generated based on at least one editing operation received in the editing interface.

In some embodiments, generating the target media content based on the at least one editing operation received in the editing interface includes: obtaining at least one update parameter via the editing interface; and triggering regeneration of the target media content based on the static media content and the at least one update parameter.

In some embodiments, obtaining the at least one update parameter via the editing interface includes: displaying a style adjustment entry in the editing interface; presenting an adjustment window in response to a selection of the style adjustment entry; and obtaining the at least one update parameter via an adjustment control associated with at least one attribute in the adjustment window.

In some embodiments, the adjustment control includes a matrix control corresponding to two attributes, and values in different dimensions of the matrix control indicate parameter values of respective attributes.

In some embodiments, the at least one update parameter is associated with a motion style of the dynamic media content.

In some embodiments, the dynamic media content indicates a motion associated with a predetermined object in the static media content.

In some embodiments, the motion is determined based on at least one of: predetermined first motion control information; second motion control information determined based on the static media content, or third motion control information determined based on user input information.

In some embodiments, the user input information includes at least one of: motion description text, an interaction operation indicating a motion trajectory, or reference media content.

In some embodiments, at least part of an image in the static media content that is independent of the predetermined object remains in a stationary state.

In some embodiments, the process 300 further includes presenting, in a chat interface of the chat, an element associated with the target media content, the element indicating that the target media content is generated based on the static media content.

### Example Device and Apparatus

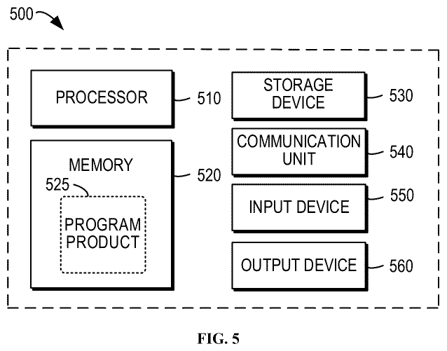

Embodiments of the present disclosure also provide a corresponding apparatus for implementing the above method or process. FIG. 4 shows a schematic structural block diagram of an example apparatus 400 for content interaction according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes: a presenting module 410 configured to present a viewing interface of static media content posted by a first user; a providing module 420 configured to provide, based on an interaction request received in the viewing interface, dynamic media content generated based on the static media content; and a sending module 430 configured to send, in response to receiving a sending request, target media content in a chat with the first user, wherein the target media content is the dynamic media content or the target media content is generated by editing the dynamic media content.

In some embodiments, an editing interface of the dynamic media content is presented; and target media content is generated based on at least one editing operation received in the editing interface.

In some embodiments, generating the target media content based on the at least one editing operation received in the editing interface includes: obtaining at least one update parameter via the editing interface; and triggering regeneration of the target media content based on the static media content and the at least one update parameter.

In some embodiments, obtaining the at least one update parameter via the editing interface includes: displaying a style adjustment entry in the editing interface; presenting an adjustment window in response to a selection of the style adjustment entry; and obtaining the at least one update parameter via an adjustment control associated with at least one attribute in the adjustment window.

In some embodiments, the adjustment control includes a matrix control corresponding to two attributes, and values in different dimensions of the matrix control indicate parameter values of respective attributes.

In some embodiments, the at least one update parameter is associated with a motion style of the dynamic media content.

In some embodiments, the dynamic media content indicates a motion associated with a predetermined object in the static media content.

In some embodiments, the motion is determined based on at least one of: predetermined first motion control information; second motion control information determined based on the static media content, or third motion control information determined based on user input information.

In some embodiments, the user input information includes at least one of: motion description text, an interaction operation indicating a motion trajectory, or reference media content.

In some embodiments, at least part of an image in the static media content that is independent of the predetermined object remains in a stationary state.

In some embodiments, the apparatus 400 further includes an element presenting module that presents, in a chat interface of the chat, an element associated with the target media content, the element indicating that the target media content is generated based on the static media content.

As shown in FIG. 5, the electronic device 500 is in the form of a general-purpose electronic device. Components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processors execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for content interaction, comprising:
presenting a viewing interface of static media content posted by a first user;
providing, based on an interaction request received in the viewing interface, dynamic media content generated based on the static media content; and
sending, in response to receiving a sending request, target media content in a chat with the first user, wherein the target media content is the dynamic media content or the target media content is generated by editing the dynamic media content.

2. The method of claim 1, further comprising:
presenting an editing interface of the dynamic media content; and
generating the target media content based on at least one edit operation received in the editing interface.

3. The method of claim 2, wherein generating the target media content based on at least one edit operation received in the editing interface comprises:
obtaining at least one update parameter via the editing interface; and
triggering regeneration of the target media content based on the static media content and the at least one update parameter.

4. The method of claim 3, wherein obtaining the at least one update parameter via the editing interface comprises:
displaying a style adjustment entry in the editing interface;
presenting an adjustment window in response to a selection of the style adjustment entry; and
obtaining the at least one update parameter via an adjustment control associated with at least one attribute in the adjustment window.

5. The method of claim 4, wherein the adjustment control comprises a matrix control corresponding to two attributes, and values in different dimensions of the matrix control indicate parameter values of respective attributes.

6. The method of claim 1, wherein the at least one update parameter is associated with a motion style of the dynamic media content.

7. The method of claim 1, wherein the dynamic media content indicates a motion associated with a predetermined object in the static media content.

8. The method of claim 7, wherein the motion is determined based on at least one of:
predetermined first motion control information,
second motion control information determined based on the static media content, or
third motion control information determined based on user input information.

9. The method of claim 8, wherein the user input information comprises at least one of:
motion description text,
an interaction operation indicating a motion trajectory, or
reference media content.

10. The method of claim 7, wherein at least part of an image of the static media content that is independent of the predetermined object remains in a stationary state.

11. The method of claim 1, further comprising:
presenting, in a chat interface of the chat, an element associated with the target media content, the element indicating that the target media content is generated based on the static media content.

12. An electronic device comprising:
at least one processor; and
at least one memory coupled to the at least one processor and storing instructions for execution by the at least one processor, the instructions, when executed by the at least one processor, causing the electronic device to perform acts comprising:
presenting a viewing interface of static media content posted by a first user;
providing, based on an interaction request received in the viewing interface, dynamic media content generated based on the static media content; and
sending, in response to receiving a sending request, target media content in a chat with the first user, wherein the target media content is the dynamic media content or the target media content is generated by editing the dynamic media content.

13. The electronic device of claim 12, the acts further comprising:
presenting an editing interface of the dynamic media content; and
generating the target media content based on at least one edit operation received in the editing interface.

14. The electronic device of claim 13, wherein generating the target media content based on at least one edit operation received in the editing interface comprises:
obtaining at least one update parameter via the editing interface; and
triggering regeneration of the target media content based on the static media content and the at least one update parameter.

15. The electronic device of claim 14, wherein obtaining the at least one update parameter via the editing interface comprises:
displaying a style adjustment entry in the editing interface;
presenting an adjustment window in response to a selection of the style adjustment entry; and
obtaining the at least one update parameter via an adjustment control associated with at least one attribute in the adjustment window.

16. The electronic device of claim 15, wherein the adjustment control comprises a matrix control corresponding to two attributes, and values in different dimensions of the matrix control indicate parameter values of respective attributes.

17. The electronic device of claim 12, wherein the at least one update parameter is associated with a motion style of the dynamic media content.

18. The electronic device of claim 12, wherein the dynamic media content indicates a motion associated with a predetermined object in the static media content.

19. The electronic device of claim 18, wherein the motion is determined based on at least one of:
predetermined first motion control information,
second motion control information determined based on the static media content, or
third motion control information determined based on user input information.

20. A non-transitory computer-readable storage medium having a computer program stored thereon, the computer program executable by a processor to implement acts comprising:
presenting a viewing interface of static media content posted by a first user;
providing, based on an interaction request received in the viewing interface, dynamic media content generated based on the static media content; and
sending, in response to receiving a sending request, target media content in a chat with the first user, wherein the target media content is the dynamic media content or the target media content is generated by editing the dynamic media content.
